(19) United States
(12) Patent Application Publication
(10) Pub. No.: US 2020/0316684 A1
(43) Pub. Date: Oct. 8, 2020

(54) ADDITIVE MANUFACTURED ALLOY COMPONENTS

(71) Applicant: Rolls-Royce Corporation, Indianapolis, IN (US)

(72) Inventor: Quinlan Yee Shuck, Indianapolis, IN (US)

(21) Appl. No.: 16/376,830

(22) Filed: Apr. 5, 2019

(51) Int. Cl. B22F 3/00; B33Y 10/00; B33Y 30/00; B33Y 50/02; B33Y 80/00; B29C 64/165; B29C 64/264; B29C 64/393

(52) U.S. Cl. CPC B22F 3/008; B33Y 10/00; B33Y 30/00; B33Y 50/02; B29K 2505/00; B29C 64/165; B29C 64/264; B29C 64/393; B33Y 80/00

(57) ABSTRACT

A method may include forming, on a surface of a substrate, a plurality of layers using an additive manufacturing technique. The plurality of layers include a first material including a first powder dispersed in a first sacrificial binder, and a second material including a second powder dispersed in a second sacrificial binder. The first powder includes a first metal or alloy, the second powder includes a second metal or alloy, and the first powder is different from the second powder. The method also includes processing the plurality of layers to remove the first and second sacrificial binders and form an additively manufactured component comprising at least one first region comprising the first powder and at least one second region comprising the second powder. At least one material characteristic of the at least one first region is different from at least one material characteristic of the at least one second region.

### TECHNICAL FIELD

The disclosure relates to additive manufacturing techniques, in particular, to additive manufacturing of alloy components.

### BACKGROUND

Additive manufacturing generates three-dimensional structures through addition of material layer-by-layer or volume-by-volume to form the structure, rather than removing material from an existing volume to generate the three-dimensional structure. Additive manufacturing may be advantageous in many situations, such as rapid prototyping, forming components with complex three-dimensional structures, or the like. In some examples, additive manufacturing may include fused deposition modeling, in which heated material, such as polymer, is extruded from a nozzle and cools to be added to the structure, or stereolithography, in which an energy source is used to selectively cure a liquid photopolymer resin to a desired shape of the component.

### SUMMARY

The disclosure describes example techniques, systems, materials, and compositions for additively manufacturing alloy components.

In some examples, the disclosure describes a method that includes forming, on a surface of a substrate, a plurality of layers using an additive manufacturing technique. The plurality of layers include a first material including a first sacrificial binder and a first powder dispersed in the first sacrificial binder, and a second material including a second sacrificial binder and a second powder dispersed in the second sacrificial binder. The first powder includes a first metal or alloy, the second powder includes a second metal or alloy, and the first powder is different from the second powder. The method also includes processing the plurality of layers to remove the first and second sacrificial binders and form an additively manufactured component comprising at least one first region comprising the first powder and at least one second region comprising the second powder. At least one material characteristic of the at least one first region is different from at least one material characteristic of the at least one second region.

In some examples, the disclosure describes an additive manufacturing system that includes a substrate defining a major surface; a first material source configured to provide a first material including a first powder dispersed in a first sacrificial binder, where the first powder includes a first metal or alloy; and a second material source configured to provide a second material including a second powder dispersed in a second sacrificial binder, where the second powder includes a second metal or alloy, and where the first powder is different from the second powder. The additive manufacturing system also includes means for additively forming layers of a material using an additive manufacturing technique; a computing device configured to control the means for additively forming layers to form a plurality of layers comprising the first material and the second material on the major surface of the substrate; and an energy source configured to remove the first and second sacrificial binders from the plurality of layers and form an additively manufactured component including at least one first region comprising the first powder and at least one second region comprising the second powder. At least one material characteristic of the at least one first region is different from at least one material characteristic of the at least one second region

In some examples, the disclosure describes an additively manufactured component that includes at least one first region comprising a first sintered powder; and at least one second region comprising a second sintered powder. The first sintered powder includes a first metal or alloy, the second sintered powder includes a second metal or alloy, the first sintered powder is different from the second sintered powder, and at least one material characteristic of the at least one first region is different from at least one material characteristic of the at least one second region.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating an example system for forming an additively manufactured component including a powder and a sacrificial binder by filament delivery.

FIG. 2 is a flow diagram illustrating an example technique for forming an additively manufactured component including at least one first region including a first powder and at least one second region including a second powder using an additive manufacturing technique.

FIG. 3 is a conceptual diagram of an additively manufactured component that includes a surface region and an internal region.

FIG. 4 is a conceptual diagram illustrating an example additively manufactured component including a first layer and a second layer.

### DETAILED DESCRIPTION

The disclosure generally describes techniques for forming additively manufactured components including metals or alloys including different regions formed from different powders, resulting in different properties in the different regions.

One advantage to additive manufacturing is the speed with which the components can be formed. Additively manufactured components thus may be less expensive, easier to prototype and revise, or the like. However, many components benefit from different properties at different portions of the component. For example, some components may benefit from regions having higher compressive stress adjacent to the surface of the component to improve fatigue performance or regions with higher creep resistance. Working additively manufactured components using thermomechanical processing after the additive manufacturing technique adds time and expense to the manufacturing process and finished components.

In accordance with this disclosure, an additive manufacturing technique may use first and second materials to deposit first and second regions. Each of the first and second materials may include a sacrificial binder and a powder. The first powder in the first material is different than the second powder in the second material. For example, the first and second powders may have substantially the same composition but may have a different average particle sizes, or a different average grain sizes within the particles. This may enable formation of first and second regions from the first and second materials, respectively, that include different grain sizes after formation of the additively manufactured component. Different grain sizes may result in different mechanical properties for the first and second regions, such as different creep resistance, toughness, fatigue performance, or the like.

As another example, the first and second powders may have different compositions. This may result in the first and second regions exhibiting different chemical properties, such as corrosion or oxidation resistance; different thermal properties, such as coefficient of thermal expansion; or the like. Using powders with different coefficients of thermal expansion may enable formation of components with portions that move in response to temperature changes without any active actuators, may enable forming of regions with residual compressive stress due to differential dimensional changes during cooling after sintering, or the like. In this way, by using two different materials that include different powders, components with more tailored properties may be achieved using additive manufacturing.

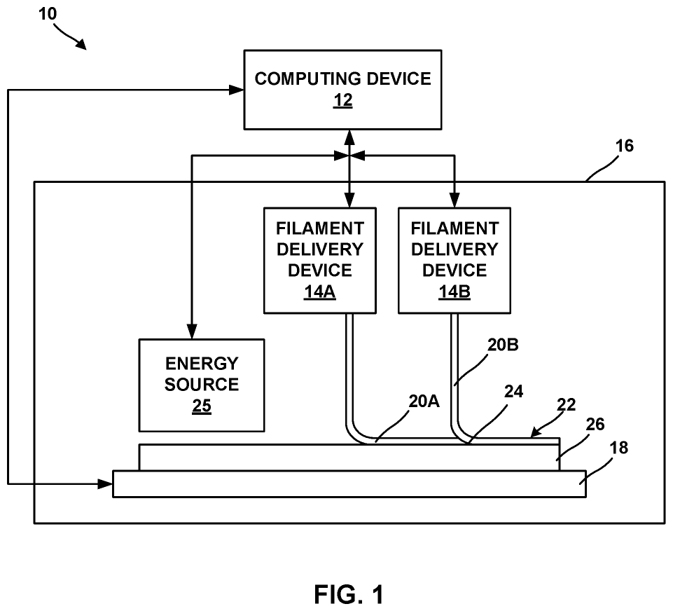

FIG. 1 is a conceptual block diagram illustrating an example additive manufacturing system 10 for performing an additive manufacturing technique to form an additively manufactured component including a powder and a binder by filament delivery. Additive manufacturing system 10 is a fused deposition modelling or fused filament fabrication system.

Additive manufacturing system 10 may include a computing device 12, a first filament delivery device 14A, a second filament delivery device 14B, an enclosure 16, and a stage 18. First and second filament delivery devices 14A and 14B are collectively referred to as filament delivery devices 14.

Computing device 12 may include, for example, a desktop computer, a laptop computer, a workstation, a server, a mainframe, a cloud computing system, or the like. Computing device 12 is configured to control operation of additive manufacturing system 10, including, for example, filament delivery devices 14, stage 18, or both. Computing device 12 may be communicatively coupled to filament delivery devices 14, stage 18, or both using respective communication connections. In some examples, the communication connections may include network links, such as Ethernet, ATM, or other network connections. Such connections may be wireless and/or wired connections. In other examples, the communication connections may include other types of device connections, such as USB, IEEE 1394, or the like. In some examples, computing device 12 may include control circuitry, such as one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Substrate 26 may include a build plate on stage 18, or any suitable substrate defining a build surface. In some examples, system 10 may not include a separate substrate 26, and softened or melted filament 20 may be deposited on a build surface defined by stage 18, or on another component, or on layers of prior softened or melted filament 20 or another material. In some examples, stage 18 may be movable under control of computing device 12 to position stage 18, substrate 16, or both, relatively to filament delivery devices 14 and energy source 25. For example, computing device 12 may control movement of stage 18 in one or more axes (e.g., three orthogonal axes along which stage 18 can translate, five axes along which stage 18 can translate and rotate, six axes along which stage 18 can translate and rotate, or the like).

FIG. 1 illustrates two filament delivery devices 14A and 14B. In general, system 10 may include a plurality of filament delivery devices (e.g., one filament delivery device for each respective material to be extruded to form the additively manufactured component). In other examples, system 10 may include a single filament delivery device that includes a plurality of reels or reservoirs holding respective materials and a corresponding number of nozzles for extruding the materials.

Regardless of the number of filament delivery devices 14, each device of filament delivery devices 14 may include one or more material delivery devices. The material delivery devices may include a filament reel that holds wound filament including a respective material, a reservoir that holds a volume of respective material, or the like. In examples in which the material delivery devices include a filament reel, computing device 12 may control filament delivery devices 14 to advance the respective filament from the reel and heat the respective filament to above a softening or melting point of the composition. The respective softened or melted filament 20A or 20B (collectively, “softened or melted filaments 20”) is then extruded from a nozzle or a die and laid down in a road 22 on a major surface 24 of a substrate 26 (or, in subsequent layers, on a previously deposited road). The softened or melted filaments 20 cool and, in this way, are joined to other roads.

Similarly, in examples in which the material delivery devices include a reservoir that holds a volume of material, computing device 12 may control filament delivery devices 14 to cause the material to flow, extrude, or draw from the reservoir and out of a respective nozzle or die of filament delivery devices 14, in the form of softened or melted filaments 20 that may be deposited on or adjacent stage 18 or substrate 26. Softened or melted filaments 20 of the composition may be dried, cured, or otherwise solidified to ultimately form an additively manufactured component. In some examples, system 10 may include an energy delivery device 25 configured to deliver energy to softened or melted filaments 20 to cure softened or melted filaments 20, for example, by photocuring or thermally curing the composition of softened or melted filaments 20.

Regardless of whether filament delivery devices 14 hold a reel of material or a volume of a material, filament delivery devices 14 are material delivery devices configured to provide a respective material. For example, first filament delivery device 14A is configured to output a first material, and the first material may include a first sacrificial binder and a first powder. Second filament delivery device 14B is configured to output a second material, and the second material may include a second sacrificial material and a second powder. The first and second powders each include a respective metal or alloy.

The metal alloy may include any suitable metal or alloy for forming an additively manufactured component. In some examples, the metal or alloy include a high-performance metal or alloy for forming component used in mechanical systems, such as a steel (e.g., stainless steel), a nickel-based alloy, a cobalt-based alloy, a titanium-based alloy, or the like. In some examples, the metal or alloy may include a nickel-based, iron-based, or titanium-based alloy that includes one or more alloying additions such as one or more of Mn, Mg, Cr, Si, Co, W, Ta, Al, Ti, Hf, Re, Mo, Ni, Fe, B, Nb, V, C, and Y. In some examples, the metal or alloy may include a polycrystalline nickel-based superalloy or a polycrystalline cobalt-based superalloy, such as an alloy including NiCrAlY or CoNiCrAlY. For example, the metal or alloy may include an alloy that includes 9 to 10.0 wt. % W, 9 to 10.0 wt. % Co, 8 to 8.5 wt. % Cr, 5.4 to 5.7 wt. % Al, about 3.0 wt. % Ta, about 1.0 wt. % Ti, about 0.7 wt. % Mo, about 0.5 wt. % Fe, about 0.015 wt. % B, and balance Ni, available under the trade designation MAR-M-247, from MetalTek International, Waukesha, Wis. In some examples, the metal or alloy may include an alloy that includes 22.5 to 24.35 wt. % Cr, 9 to 11 wt. % Ni, 6.5 to 7.5 wt. % W, less than about 0.55 to 0.65 wt. % of C, 3 to 4 wt. % Ta, and balance Co, available under the trade designation MAR-M-509, from MetalTek International. In some examples, the metal or alloy may include an alloy that includes 19 to 21 wt. % Cr, 9 to 11 wt. % Ni, 14 to 16 wt. % W, about 3 wt. % Fe, 1 to 2 wt. % Mn, and balance Co, available under the trade designation L605, from Rolled Alloys, Inc., Temperance, Mich. In some examples, a metal or alloy may include a chemically modified version of MAR-M-247 that includes less than 0.3 wt. % C, between 0.05 and 4 wt. % Hf, less than 8 wt. % Re, less than 8 wt. % Ru, between 0.5 and 25 wt. % Co, between 0.0001 and 0.3 wt. % B, between 1 and 20 wt. % Al, between 0.5 and 30 wt. % Cr, less than 1 wt. % Mn, between 0.01 and 10 wt. % Mo, between 0.1 and 20.% Ta, and between 0.01 and 10 wt. % Ti. In some examples, the metal or alloy may include a nickel based alloy available under the trade designation IN-738 or Inconel 738, or a version of that alloy, IN-738 LC, available from All Metals & Forge Group, Fairfield, N.J., or a chemically modified version of IN-738 that includes less than 0.3 wt. % C, between 0.05 and 7 wt. % Nb, less than 8 wt. % Re, less than 8 wt. % Ru, between 0.5 and 25 wt. % Co, between 0.0001 and 0.3 wt. % B, between 1 and 20 wt. % Al, between 0.5 and 30 wt. % Cr, less than 1 wt. % Mn, between 0.01 and 10 wt. % Mo, between 0.1 and 20 wt. % Ta, between 0.01 and 10 wt. % Ti, and a balance Ni. In some examples, the metal or alloy may include may include an alloy that includes 5.5 to 6.5 wt. % Al, 13 to 15 wt. % Cr, less than 0.2 wt. % C, 2.5 to 5.5 wt. % Mo, Ti, Nb, Zr, Ta, B, and balance Ni, available under the trade designation IN-713 from MetalTek International, Waukesha, Wis.

In some examples, in addition to a metal or alloy, the powder may include a ceramic, such as an oxide. For example, the powder may include an oxide-dispersion strengthened (ODS) alloy. The ODS alloy may include at least one of a superalloy or a particle-dispersion strengthened alloy. ODS alloys are alloys strengthened through the inclusion of a fine dispersion of oxide particles. For example, an ODS alloy may include a high temperature metal matrix (e.g., any of the metals or alloys described above) that further include oxide nanoparticles, for example, yttria (Y₂O₃). Other example ODS alloys include nickel chromium ODS alloys, thoria-dispersion strengthened nickel and nickel chromium alloys, nickel aluminide and iron aluminide ODS alloys, iron chromium aluminide ODS alloys. Other strengthening particles may include alumina, hafnia, zirconia, beryllia, magnesia, titanium oxide, and carbides including silicon carbide, hafnium carbide, zirconium carbide, tungsten carbide, and titanium carbide.

Powders including ODS alloys may be formed by, for example, mixing a plurality of particles of metal(s) and oxide(s) forming the ODS alloy to form a mixture, optionally melting at least part of the mixture to form a melted mixture including oxide particles, and, if the mixture is melted, atomizing the melted mixture into the powdered form. Alternatively, the powdered form of the ODS alloy may be provided by hydrometallurgical processes, or any suitable technique for preparing an ODS alloy.

In some examples, ODS alloys may be characterized by the dispersion of fine oxide particles and by an elongated grain shape, which may enhance high temperature deformation behavior by inhibiting intergranular damage accumulation.

The materials in the filaments or the reservoir within filament delivery devices 14 may also include a sacrificial binder. The sacrificial binders may include a polymeric material, such as a thermoplastic. Example thermoplastics include polyvinyl alcohol, polyolefins, polystyrene, acrylonitrile butadiene styrene, polylactic acid, thermoplastic polyurethanes, aliphatic polyamides, or the like, or combinations thereof. The powders may be dispersed in the corresponding sacrificial binders, for example substantially uniformly dispersed in the corresponding sacrificial binders. In some examples, the sacrificial binders in the first and second materials may be the same; in other examples, the sacrificial binders may be different.

In some examples, the sacrificial binder(s) may be in the form of a curable polymer precursor. The curable polymer precursor may be curable (for example, thermally curable or photocurable) to form the sacrificial binder. For example, the curable polymer precursor may be cured as melted or softened filaments 20 are extruded and/or after melted or softened filaments 20 are laid down in roads 22 to form a material including the powder dispersed in the sacrificial binder, for example substantially uniformly dispersed in the binder. The curable polymer precursor may include a precursor, for example, one or more monomers, oligomers, or non-crosslinked polymers suitable for forming the polymeric material of the sacrificial binder upon curing. Thus, in some examples, energy source 25 may direct energy at a curable polymer precursor, for example, in the material, to selectively cure the curable polymer precursor to form the roads 22 including the material that includes the powder including the metal or alloy and the sacrificial binder. In other examples, the heat to which the composition is exposed to form melted or softened filaments 20 may initiate the curing reaction, and no additional energy source is used.

In some examples, the composition may include, instead of, or in addition to, the curable polymer precursor, a flowable carrier. The flowable carrier may impart flowability to the composition, such that the composition may be extruded or drawn from filament delivery device 14 as filaments 20. The flowable carrier may be removed from filaments 20, for example, by drying, evaporation, or the like, to cause filaments 20 to solidify. The flowable carrier may include an organic or inorganic solvent or mixture of solvents. In some examples, instead of, or in addition to, one or more solvents, the flowable carrier may include one or more of a gel, a resin, a monomer, an oligomer, a polymer, or a lubricant. In some examples, one or more of the resin, monomer, oligomer, or polymer may be substantially the same as the curable polymer precursor. In other examples, one or more of the resin, monomer, oligomer, or polymer may be different from the curable polymer precursor.

In some examples, the first and second materials include a selected amount of sacrificial binder and powder including the metal or alloy so that the material(s) in roads 22 includes more than about 80% by volume of the powder including the metal or alloy, which may result in a rigid component being formed in response to selective removal of the sacrificial binder. In some examples, the material(s) in roads 22 includes sacrificial binder in an amount configured to cause the material(s) to shrink by less than about 20 volume percent relative to an initial volume of the material(s) in response to selectively removing the sacrificial binder. For example, the material(s) in roads 22 may include less than about 20% by volume of the sacrificial binder.

In some examples, the material(s) in roads 22 includes at least one shrink-resistant agent. For example, the at least one shrink-resistant agent may include a ceramic, instead of, or in addition to, the oxide in any ODS present in the material(s).

As mentioned above, each of the materials deposited by the respective filament delivery devices 14 includes a corresponding material. For example, first filament delivery device 14A may dispense a melted or softened filament 20A that includes a first material and second filament delivery device 14B may dispense a melted or softened filament 20B that includes a second material. Each of the first and second materials may include a sacrificial binder and a powder. The first powder in the first material may include a first metal or alloy, and the second powder in the second material may include a second metal or alloy. The first powder is different than the second powder in the second material in at least one respect. For example, the first and second powders may have substantially the same composition (e.g., may be the same metal or alloy) but may have a different average particle sizes, or a different average grain sizes within the particles. This may enable formation of first and second regions from the first and second materials, respectively, that include different grain sizes after formation of the additively manufactured component. Different grain sizes may result in different mechanical properties for the first and second regions, such as different creep resistance, toughness, fatigue performance, or the like.

As another example, the first and second powders may have different compositions (e.g., may include different metals or alloys). This may result in the first and second regions exhibiting different chemical properties, such as corrosion or oxidation resistance; different thermal properties, such as coefficient of thermal expansion; or the like. For example, computing device 12 may control first filament delivery device 14A to deliver a first material to selected locations that will form an interior region of an additively manufactured component. The first material may include a first metal or alloy that includes relatively poorer oxidation or corrosion resistance than a second metal or alloy. Computing device 12 may control second filament delivery device 14B to deliver e second material to selected locations that will form an exterior region of the additively manufactured component. The second metal alloy thus may be located at regions of the additively manufactured component that will be exposed to oxygen or corrosive species and may provide superior oxidation or corrosion resistance compared to an additively manufactured component manufactured using only the first metal or alloy.

As another example, the first material may include a first metal or alloy powder and the second material may contain a blend of the first metal or alloy powder and a second, different metal alloy or powder to facilitate a common sintering process.

As another example, using powders with different coefficients of thermal expansion may enable formation of components with regions that move in response to temperature changes without any active actuators. For example, computing device 12 may control first filament delivery device 14A to deliver a first material to selected locations that will form a first layer of a turbine shroud or blade track. The first layer may define a blade-facing surface of the turbine shroud or blade track. The first material may include a first metal or alloy that exhibits higher coefficient of thermal expansion than a second metal or alloy. Computing device 12 may control second filament delivery device 14B to deliver the second material to selected locations that will form the opposite surface of the turbine shroud or blade track (facing away from the blade). The blade track may be cantilevered from a support, such that one circumferential side is allowed to float. As the blade track heats, the first metal or alloy will expand to a greater extent than the second metal or alloy, causing the blade track to expand in circumference. Conversely, as the blade track cools, the first metal or alloy will compress to a greater extent than the second metal or alloy, causing the blade track to decrease in circumference. By careful selection of materials and dimensions, the change in circumference may be selected to substantially match a change in length of the corresponding gas turbine engine blades, resulting in more consistent gaps between tips of the gas turbine engine blades and the turbine shroud or blade track and better efficiency over a range of temperatures, all without active (e.g., hydraulic, electronic, or pneumatic) control elements.

As another example, using powders with different coefficients of thermal expansion may enable forming of regions with residual compressive stress due to differential dimensional changes during cooling after sintering. For example, computing device 12 may control first filament delivery device 14A to deliver a first material to selected locations that will form an interior region of an additively manufactured component. The first material may include a first metal or alloy that exhibits a higher coefficient of thermal expansion than a second metal or alloy. Computing device 12 may control second filament delivery device 14B to deliver the second material to selected locations that will form a surface region of the additively manufactured component. The additively manufacture component may be sintered to densify the component, and during cooling, the first metal or alloy will contract more than the second metal or alloy, inducing compressive stress in the surface region. The compressive stress may improve fatigue performance of the component, which may be important for additively manufactured components that generally include surface finishes that hurt fatigue performance.

Regardless of how roads 22 are deposited, roads 22 includes the first and second materials. In some examples, a single road may include both the first and second materials, e.g., in examples in which a single layer of the additively manufactured component will include the first powder at a first region of the additively manufactured component and the second powder at a second region of the additively manufactured component of. In other examples, a single road may include only the first material or only the second material. Once computing device 12 has controlled filament delivery devices 14 to deposit all roads 22 of the additively manufactured component, the sacrificial binder(s) may be selectively sacrificed from road 22, to substantially leave only the powder in road 22. In some examples, the sacrificial binder may be periodically removed from one or more roads 22 after depositing a predetermined number of roads 22. In other examples, the sacrificial binder may be removed after a complete component including a plurality of roads 22 is fabricated, to substantially leave only the powder in the component.

In some examples, system 10 may optionally include an energy source 25. Energy source 25 may be configured to deliver energy to cure a curable polymer precursor, selectively sacrifice the sacrificial binder, or both. In this way, computing device may be configured to control an amount or a rate of energy delivered by energy source 25 to melted or softened filaments 20, roads 22, or both to accomplish the desired effect. Energy source 25 may include a thermal energy source, a microwave energy source, an electrical energy source, an ultrasound energy source, a photoenergy source, a chemical energy source, or any energy source suitable or configured to cause the sacrificial binder to be selectively sacrificed while substantially leaving the powder including the metal or alloy intact. In some examples, system 10 may include a chamber for containing and dispensing a composition capable of selectively chemically sacrificing the sacrificial binder, for example, a solvent, reactant, or a suitable medium for chemically removing the sacrificial binder, for example, from one or more layers of an additively manufactured component, or from a completely built component.

In some examples, additive manufacturing system 10 includes enclosure 16, which at least partially encloses filament delivery devices 14, stage 18, and substrate 26. Enclosure 16 may provide physical protection to filament delivery devices 14, stage 18, and substrate 26 during operation of additive manufacturing system 10, may maintain an atmosphere within enclosure 16 in a desired state (e.g., filled with an inert gas, under vacuum, or maintained at a desired temperature), or the like. In some examples, enclosure 16 may define a furnace or another thermal chamber or environment in which any predetermined temperature sufficient to thermally sacrifice the binder may be maintained. In some examples, enclosure 16 may include thermally insulative walls, and energy source 25 within enclosure 16 may provide a source of heat to cause an interior of enclosure 16 to be heated. In some examples, one or more heating elements or coils may be disposed in or on walls of enclosure 16 to cause an interior of enclosure 16 to be heated.

Computing device 12 may be configured to control movement and positioning of filament delivery devices 14 relative to stage 18, and vice versa, to control the locations at which roads 22 are formed. Computing device 12 may control movement of filament delivery devices 14, stage 18, or both, based on a computer aided manufacturing or computer aided design (CAM/CAD) file. For example, computing device 12 may control filament delivery devices 14 to trace a pattern or shape to form a layer including a plurality of roads 22 on surface 24. Computing device 12 may control filament delivery devices 14 or stage 18 to move substrate 26 away from filament delivery devices 14, then control filament delivery devices 14 to trace a second pattern or shape to form a second layer including a plurality of roads on the first layer. Computing device 12 may control stage 18 and filament delivery devices 14 in this manner to result in a plurality of layers, each layer including a traced shape or design. Together, the plurality of layers defines an additively manufactured component.

Computing device 12 may be configured to control filament delivery devices 14 together (such that both filament delivery devices 14 move at the same time in the same direction(s)) or independently (such that each filament delivery device of filament delivery devices 14 may move at a different time, in a different direction, at a different rate, or the like). Computing device 12 also is configured to control filament delivery devices 14 independently to cause each respective filament delivery device to extrude or dispense material at selected times to selected locations, which may be based on a CAM/CAD file.

After computing device 12 has controlled filament delivery devices 14 to deposit one or more layers of the additively manufactured component (e.g., from a plurality of adjacent roads 22), or after the complete component is formed by additive manufacturing, the component may be subjected to further treatment, for example, to selectively remove the binder to leave only the powder including the metal or alloys, to sinter the powder for form a component, or both. In some examples, system 10 may include a heating element or an energy delivering device, for example, energy source 25, for delivering energy suitable to selectively remove the sacrificial binder while leaving the powder, to sinter the powder, or both. For example, after sacrificing the binder, energy source 25 or other heating elements or coils in, on, or adjacent to walls of enclosure 16 may be used to provide thermal energy to maintain a temperature sufficient for sintering the powder.

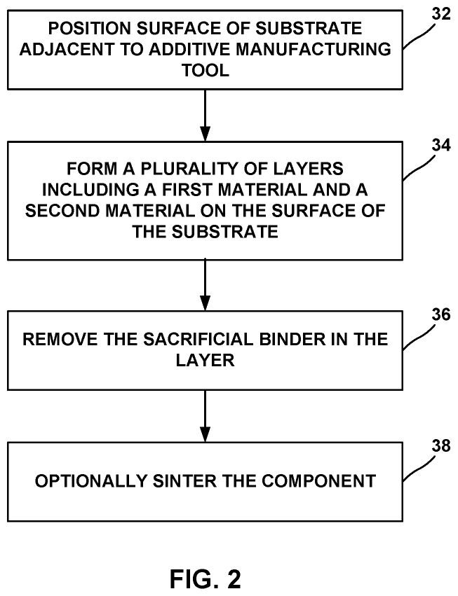

FIG. 2 is a flow diagram illustrating an example technique for forming an additively manufactured component including at least one first region including a first powder and at least one second region including a second powder using an additive manufacturing technique. Although the technique of FIG. 2 is described with respect to system 10 of FIG. 1, in other examples, the technique of FIG. 2 may be performed by other systems. Similarly, system 10 may be used to performed other additive manufacturing techniques.

The technique of FIG. 2 includes positioning substrate 26 including surface 24 adjacent to a build position, e.g., on stage 18 (32). In some examples, system 10 may not include a separate substrate 26, the technique of FIG. 2 may include positioning a build surface defined by stage 18, or by another component, or layers of prior softened or melted filament 20 or another material.

The technique of FIG. 2 also includes forming a plurality of layers of material on surface 24 using an additive manufacturing technique (34). Each layer of material may include at least one and possibly a plurality of roads 22. The material includes a first material including a first metal or alloy powder dispersed in a first sacrificial binder and a second material including a second metal or a powder including a second metal or alloy dispersed in a second sacrificial binder. The first and second sacrificial binders may be the same or different.

The first and second metal or alloys may be different in at least one respect. For example, the first and second powders may have substantially the same composition (e.g., may be the same metal or alloy) but may have a different average particle sizes, or a different average grain sizes within the particles. This may enable formation of first and second regions from the first and second materials, respectively, that include different grain sizes after formation of the additively manufactured component. Different grain sizes may result in different mechanical properties for the first and second regions, such as different creep resistance, toughness, fatigue performance, or the like.

As another example, the first and second powders may have different compositions (e.g., may include different metals or alloys). This may result in the first and second regions exhibiting different chemical properties, such as corrosion or oxidation resistance; different thermal properties, such as coefficient of thermal expansion; or the like; as described above.

Computing device 12 may cause filament delivery devices 14 to deposit softened or melted filaments 20A and 20B at selected locations in one or more roads 22 to ultimately form the additively manufactured component. A plurality of roads 22 defining a common plane may define a layer of material. Thus, successive roads 22 may defines a series of layers, for example, parallel layers, and the series of layers may eventually define the additively manufactured component. Each road may include the first material, the second material, or both, just as each layer may include the first material, the second material, or both. The material content of each road and each layer may be defined by a CAM/CAD file, based upon which computing device 12 controls the position and filament dispensing by filament delivery devices 14.

In some examples, computing device 12 may control movement and positioning of filament delivery devices 14 relative to stage 18, and vice versa, to control the locations at which roads 22 are formed. Computing device 12 may control movement of filament delivery devices 14, stage 18, or both, based on a computer aided manufacturing or computer aided design (CAM/CAD) file. For example, computing device 12 may control filament delivery devices 14 to trace a pattern or shape to form a layer including a plurality of roads 22 on surface 24. Computing device 12 may control filament delivery devices 14 or stage 18 to move substrate 26 away from filament delivery devices 14, then control filament delivery device 14 to trace a second pattern or shape to form a second layer including a plurality of roads on the previously deposited layer. Computing device 12 may control stage 18 and filament delivery devices 14 in this manner to result in the plurality of layers, each layer including a traced shape or design. Together, the plurality of layers defines an additively manufactured component.

The technique of FIG. 2 also includes removing the sacrificial binder in roads 22 (36). For example, the technique may include alternating deposition or formation of roads 22 and sacrificing the binder in or more one roads 22 in a partially formed additively manufactured component. The removing of the sacrificial binder (36) may include delivering thermal or any suitable energy (e.g., chemical), for example, by energy source 25, to roads 22 sufficient to cause the sacrificial binder to be dissolved, substantially oxidized, incinerated, carbonized, charred, decomposed, or removed from roads 22, while leaving the first and second powders substantially intact. In some examples, the technique of FIG. 2 may include alternating the selective removal of the binder (36) and the forming layers of softened or melted filament 20 (34). In other examples, the sacrificial binder may be removed (36) after all the layers of material have been deposited to define the additively manufacture component.

The technique of FIG. 2 optionally includes, after removing the sacrificial binder (36) (or after otherwise forming the component from which the sacrificial binder is removed to leave only the powders), sintering the component (38). The sintering may include a thermal treatment, for example, one or more predetermined cycles of exposure to predetermined temperatures for predetermined times. In some examples, computing device 12 may control energy source 25 to deliver the energy to cause sintering. The sintering (38) may promote the bonding of particles of powder to each other to strengthen and/or densify the component including substantially only the powders after the sacrificial binder is removed. In some examples, the sintering (38) includes heating the component to two or more different temperatures to accomplish sintering of the first and second metal or alloys.

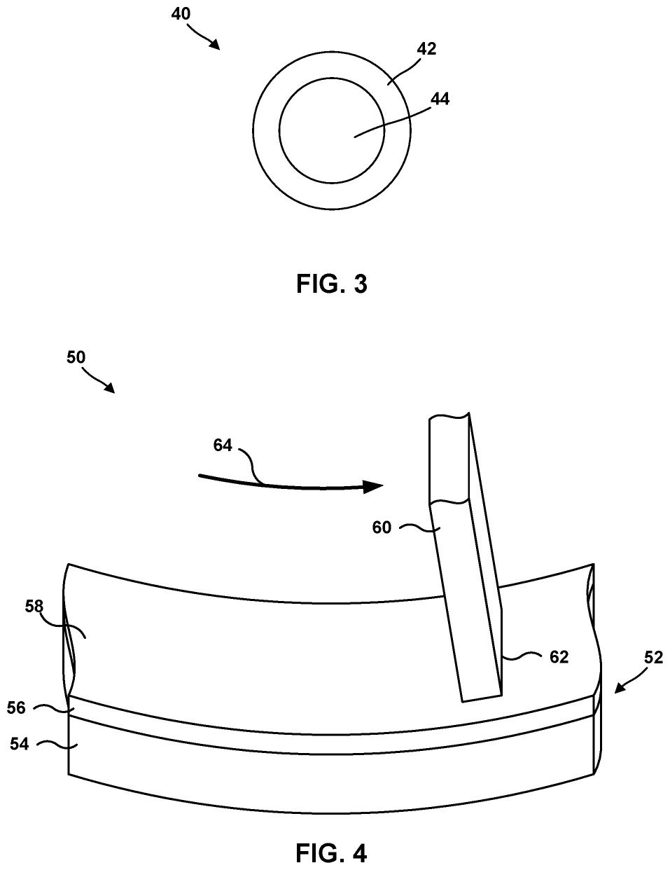

FIG. 3 is a conceptual diagram of an additively manufactured component 40 that includes a surface region 42 and an internal region 44. Surface region 42 is formed from a first powder that includes a first metal or alloy internal region 44 is formed from a second powder that includes a second metal or alloy. The first powder is different than the second powder in the second material in at least one respect. For example, the first and second powders may have substantially the same composition (e.g., may be the same metal or alloy) but the first powder may have a smaller average particle size, or a smaller average grain sizes within the particles than the second powder. This may enable surface region 42 to exhibit improved creep resistance, toughness, fatigue performance, or the like, compared to a surface region 42 formed from the second powder.

As another example, the first and second powders may have different compositions (e.g., may include different metals or alloys). For example, the first powder may include a first metal or alloy that includes superior oxidation or corrosion resistance than the second metal or alloy to provide superior oxidation or corrosion resistance to surface region 42. The second powder may include a second metal or alloy that provides superior mechanical properties.

As another example, the first powder may include a first metal or alloy that exhibits a lower coefficient of thermal expansion than the second metal or alloy in the second powder. Additively manufactured component 40 may be sintered to densify the component, and during cooling, the first metal or alloy in surface region 42 will contract more than the second metal or alloy in internal region 44, inducing compressive stress in surface region 42. The compressive stress may improve fatigue performance of component 40, which may be important for additively manufactured components, which generally include surface finishes that hurt fatigue performance.

FIG. 4 is a conceptual diagram illustrating a system 50 that includes an example additively manufactured component 52 including a first layer 54 and a second layer 56. In the example of FIG. 4, additively manufactured component 52 includes a gas turbine blade track or gas turbine blade shroud. System 50 also includes a gas turbine blade 60, which includes a blade tip 62 adjacent to surface 58 of additively manufactured component 52. Gas turbine blade 60 rotates in circumferential direction 64.

As system 50 operates as part of a gas turbine engine, gas turbine blade 60 and additively manufactured component 52 experience changes in temperature, e.g., generally heat up during operation and cool upon the engine being turned off. As gas turbine blade 60 heats, thermal expansion causes gas turbine blade 60 to lengthen towards surface 58. Conversely, as gas turbine blade 60 cools, thermal expansion causes gas turbine blade 60 to contract away from surface 58. Any gap between blade tip 62 and surface 58 allows gas flow through the gap, reducing efficiency of the gas turbine engine.

By forming additively manufactured component 52 to include a first layer 54 and a second layer 56, additively manufactured component 52 may exhibit passive dimensional changes during heating and cooling that may reduce the gap between blade tip 62 and surface 58. For example, first layer 54 may formed from a first material that includes a first metal or alloy that exhibits a lower coefficient of thermal expansion than a second metal or alloy from which second layer 56 is formed. Additively manufactured component 52 may be cantilevered from a support, such that one circumferential side is allowed to float. As the blade track heats, second layer 56 including the second metal or alloy will expand to a greater extent than first layer 54 including the first metal or alloy, causing the blade track to expand in circumference and move away from blade tip 62. Conversely, as the blade track cools, the second metal or alloy in second layer 56 will compress to a greater extent than the first metal or alloy in first layer 54, causing the blade track to decrease in circumference and move toward blade tip 62. By careful selection of materials and dimensions, the change in circumference may be selected to substantially match a change in length of gas turbine engine blade 60, resulting in more consistent gaps between blade tip 62 the turbine shroud or blade track and better efficiency over a range of temperatures, all without active (e.g., hydraulic, electronic, or pneumatic) control elements.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Clause 1: A method comprising: forming, on a surface of a substrate, a plurality of layers using an additive manufacturing technique, wherein the plurality of layers comprise a first material comprising a first sacrificial binder and a first powder dispersed in the first sacrificial binder and a second material comprising a second sacrificial binder and a second powder dispersed in the second sacrificial binder, wherein the first powder comprises a first metal or alloy, wherein the second powder comprises a second metal or alloy, and wherein the first powder is different from the second powder; and processing the plurality of layers to remove the first and second sacrificial binders and form an additively manufactured component comprising at least one first region comprising the first powder and at least one second region comprising the second powder, wherein at least one material characteristic of the at least one first region is different from at least one material characteristic of the at least one second region.

Clause 2: The method of clause 1, wherein the additive manufacturing technique comprises fused deposition modeling.

Clause 3: The method of clause 1 or 2, further comprising directing an energy source at a curable polymer precursor to selectively cure the curable polymer precursor to form the layer of material.

Clause 4: The method of clause 3, wherein the binder comprises a polymer formed by curing of the curable polymer precursor.

Clause 5: The method of any one of clauses 1 to 4, further comprising sintering the additively manufactured component.

Clause 6: The method of clause 5, wherein sintering the additively manufacture component comprises a two-step heating process, each step of the two-step heating process selected based on the first powder and the second powder.

Clause 7: The method of any one of clauses 1 to 6, wherein the first powder has a composition different from the second powder.

Clause 8: The method of any one of clauses 1 to 7, wherein the second material further comprises the first powder.

Clause 9: The method of any one of clauses 1 to 8, wherein the first powder has an average particle size that is different from the second powder.

Clause 10: The method of any one of clauses 1 to 9, wherein the at least one material characteristic comprises at least one of creep resistance, corrosion resistance, toughness, coefficient of thermal expansion, or density.

Clause 11: An additive manufacturing system comprising: a substrate defining a major surface; a first material source configured to provide a first material comprising a first powder dispersed in a first sacrificial binder, wherein the first powder comprises a first metal or alloy; a second material source configured to provide a second material comprising a second powder dispersed in a second sacrificial binder, wherein the second powder comprises a second metal or alloy, and wherein the first powder is different from the second powder; means for additively forming layers of a material using an additive manufacturing technique; a computing device configured to control the means for additively forming layers to form a plurality of layers comprising the first material and the second material on the major surface of the substrate; and an energy source configured to remove the first and second sacrificial binders from the plurality of layers and form an additively manufactured component comprising at least one first region comprising the first powder and at least one second region comprising the second powder, wherein at least one material characteristic of the at least one first region is different from at least one material characteristic of the at least one second region.

Clause 12: The additive manufacturing system of clause 11, wherein the means for additively forming layers of material comprises: a fused deposition modeling device comprising a first filament delivery device configured to output a first heated filament comprising the first material and a second filament delivery device configured to output a second heated filament comprising the second material.

Clause 13: The additive manufacturing system of clause 11 or 12, wherein the means for additively forming layers of material comprises: an energy source configured to output energy to selectively cure a curable polymer precursor to form the first material and the second material.

Clause 14: The additive manufacturing system of clause 13, wherein the first and second sacrificial binder comprise a polymer formed by curing of the curable polymer precursor.

Clause 15: The additive manufacturing system of any one of clauses 11 to 14, wherein the heat source is further configured to sinter the additively manufacture component using a two-step heating process, each step of the two-step heating process selected based on the first powder and the second powder.

Clause 16: The additive manufacturing system of any one of clauses 11 to 15, wherein the first powder has a composition different from the second powder.

Clause 17: The additive manufacturing system of any one of clauses 11 to 16, wherein the second material further comprises the first powder.

Clause 18: The additive manufacturing system of any one of clause 11 to 17, wherein the first powder has an average particle size that is different from the second powder.

Clause 19: The additive manufacturing system of any one of clauses 11 to 18, wherein the at least one material characteristic comprises at least one of creep resistance, corrosion resistance, toughness, coefficient of thermal expansion, or density.

Clause 20: An additively manufactured component comprising: at least one first region comprising a first sintered powder; and at least one second region comprising a second sintered powder, wherein the first powder comprises a first metal or alloy, wherein the second powder comprises a second metal or alloy, wherein the first powder is different from the second powder, and wherein at least one material characteristic of the at least one first region is different from at least one material characteristic of the at least one second region.

Clause 21: The additively manufactured component of claim 20, wherein the first powder has a composition different from the second powder.

Clause 22: The additively manufactured component of claim 20 or 21, wherein the second material further comprises the first powder.

Clause 23: The additively manufactured component of any one of clauses 20 to 22, wherein the first powder has an average particle size that is different from the second powder.

Clause 23: The additively manufactured component of any one of clauses 20 to 23, wherein the at least one material characteristic comprises at least one of creep resistance, corrosion resistance, toughness, coefficient of thermal expansion, or density.

Clause 24: The additively manufactured component of any one of clauses 20 to 23, wherein the at least one first region comprises a surface region of the additively manufactured component, wherein the at least one second region comprises an internal region of the additively manufactured component, wherein the first metal or alloy exhibits a first coefficient of thermal expansion, wherein the second metal or alloy exhibits a second coefficient of thermal expansion, wherein the first coefficient of thermal expansion is less than the second coefficient of thermal expansion, wherein the at least one material characteristic is fatigue performance.

Clause 25: The additively manufactured component of any one of clauses 20 to 24, wherein the at least one first region comprises a first layer of a blade track configured to be located adjacent to a blade tip, wherein the at least one second region comprises a second layer of the blade track configured to be located on the opposite side of the first layer from the blade tip, and wherein the first metal or alloy exhibits a higher coefficient of thermal expansion than the second metal or alloy.

Various examples have been described. These and other examples are within the scope of the following claims.

What is claimed is:

1. A method comprising:
forming, on a surface of a substrate, a plurality of layers using an additive manufacturing technique, wherein the plurality of layers comprise a first material comprising a first sacrificial binder and a first powder dispersed in the first sacrificial binder and a second material comprising a second sacrificial binder and a second powder dispersed in the second sacrificial binder, wherein the first powder comprises a first metal or alloy, wherein the second powder comprises a second metal or alloy, and wherein the first powder is different from the second powder; and
processing the plurality of layers to remove the first and second sacrificial binders and form an additively manufactured component comprising at least one first region comprising the first powder and at least one second region comprising the second powder, wherein at least one material characteristic of the at least one first region is different from at least one material characteristic of the at least one second region.

2. The method of claim 1, wherein the additive manufacturing technique comprises fused deposition modeling.

3. The method of claim 1, further comprising directing an energy source at a curable polymer precursor to selectively cure the curable polymer precursor to form the layer of material.

4. The method of claim 1, further comprising sintering the additively manufactured component.

5. The method of claim 4, wherein sintering the additively manufacture component comprises a two-step heating process, each step of the two-step heating process selected based on the first powder and the second powder.

6. The method of claim 1, wherein the first powder has a composition different from the second powder.

7. The method of claim 1, wherein the first powder has an average particle size that is different from the second powder.

8. The method of claim 1, wherein the at least one material characteristic comprises at least one of creep resistance, corrosion resistance, toughness, coefficient of thermal expansion, or density.

9. An additive manufacturing system comprising:
a substrate defining a major surface;
a first material source configured to provide a first material comprising a first powder dispersed in a first sacrificial binder, wherein the first powder comprises a first metal or alloy;
a second material source configured to provide a second material comprising a second powder dispersed in a second sacrificial binder, wherein the second powder comprises a second metal or alloy, and wherein the first powder is different from the second powder;
means for additively forming layers of a material using an additive manufacturing technique;
a computing device configured to control the means for additively forming layers to form a plurality of layers comprising the first material and the second material on the major surface of the substrate; and
an energy source configured to remove the first and second sacrificial binders from the plurality of layers and form an additively manufactured component comprising at least one first region comprising the first powder and at least one second region comprising the second powder, wherein at least one material characteristic of the at least one first region is different from at least one material characteristic of the at least one second region.

10. The additive manufacturing system of claim 9, wherein the means for additively forming layers of material comprises:
a fused deposition modeling device comprising a first filament delivery device configured to output a first heated filament comprising the first material and a second filament delivery device configured to output a second heated filament comprising the second material.

11. The additive manufacturing system of claim 9, wherein the means for additively forming layers of material comprises:
an energy source configured to output energy to selectively cure a curable polymer precursor to form the first material and the second material.

12. The additive manufacturing system of claim 9, wherein the heat source is further configured to sinter the additively manufacture component using a two-step heating process, each step of the two-step heating process selected based on the first powder and the second powder.

13. The additive manufacturing system of claim 9, wherein the first powder has a composition different from the second powder.

14. The additive manufacturing system of claim 9, wherein the first powder has an average particle size that is different from the second powder.

15. The additive manufacturing system of claim 9, wherein the at least one material characteristic comprises at least one of creep resistance, corrosion resistance, toughness, coefficient of thermal expansion, or density.

16. An additively manufactured component comprising:
at least one first region comprising a first sintered powder; and
at least one second region comprising a second sintered powder, wherein the first powder comprises a first metal or alloy, wherein the second powder comprises a second metal or alloy, wherein the first powder is different from the second powder, and wherein at least one material characteristic of the at least one first region is different from at least one material characteristic of the at least one second region.

17. The additively manufactured component of claim 16, wherein the first powder has a composition different from the second powder.

18. The additively manufactured component of claim 16, wherein the first powder has an average particle size that is different from the second powder.

19. The additively manufactured component of claim 18, wherein the at least one material characteristic comprises at least one of creep resistance, corrosion resistance, toughness, coefficient of thermal expansion, or density.

20. The additively manufactured component of claim 16, wherein the at least one first region comprises a surface region of the additively manufactured component, wherein the at least one second region comprises an internal region of the additively manufactured component, wherein the first metal or alloy exhibits a first coefficient of thermal expansion, wherein the second metal or alloy exhibits a second coefficient of thermal expansion, wherein the first coefficient of thermal expansion is less than the second coefficient of thermal expansion, wherein the at least one material characteristic is fatigue performance.

21. The additively manufactured component of claim 16, wherein the at least one first region comprises a first layer of a blade track configured to be located adjacent to a blade tip, wherein the at least one second region comprises a second layer of the blade track configured to be located on the opposite side of the first layer from the blade tip, and wherein the first metal or alloy exhibits a higher coefficient of thermal expansion than the second metal or alloy.
